(19) United States
(12) Patent Application Publication
(10) Pub. No.: US 2026/0020539 A1
(43) Pub. Date: Jan. 22, 2026

(54) TWO-WAY CLIP FOR HANGING ANIMAL FEEDERS

(71) Applicants: Tyler Phillips, Germantown, MD (US); William Stefany, Gaithersburg, MD (US)

(72) Inventors: Tyler Phillips, Germantown, MD (US); William Stefany, Gaithersburg, MD (US)

(21) Appl. No.: 18/775,107

(22) Filed: Jul. 17, 2024

(51) Int. Cl. A01K 1/035; F16B 2/24

(52) U.S. Cl. CPC A01K 1/0356; F16B 2/248

(57) ABSTRACT

A two-way clip designed for hanging animal feeders and water containers within or outside wire mesh enclosures is provided. The clip includes a first end section with a circular opening for attachment to a feeder's pivotal point, a second end section featuring a U-shaped hook with outwardly bent tips for secure engagement with wire mesh, and a cylindrical connecting member providing structural integrity. This design allows the clip to securely attach feeders from either side of the enclosure without removal. The clip is fabricated from durable materials, accommodates varying wire thicknesses, and includes features for rotational movement, quick-release, and locking mechanisms. It ensures stability, ease of use, and compatibility with different wire mesh configurations, enhancing feeding and watering systems in animal husbandry.

### FIELD OF THE INVENTION

The present invention relates to the field of animal husbandry, specifically to devices and apparatuses designed for feeding and watering animals housed in enclosures. More particularly, it relates to clips and attachment mechanisms used to hang feeders and water containers within or outside animal cages and hutches.

### BACKGROUND

In the context of animal husbandry, providing a reliable and efficient feeding and watering system is crucial for maintaining the health and well-being of animals. Animals such as chickens, rabbits, and other small livestock are often kept in enclosures made of wire mesh, which offers protection and containment while allowing visibility and ventilation. These enclosures necessitate a method for securely attaching feeders and water containers to ensure easy access for the animals.

Traditionally, various types of clips and hooks have been used to hang feeders and water containers on wire mesh structures. However, these existing solutions often present several limitations and challenges: Many conventional clips are designed to attach feeders to either the inside or the outside of the enclosure, but not both. This single-sided functionality limits the flexibility in feeder placement and requires multiple types of clips for different mounting options. Also, ensuring that the feeders remain securely attached to the wire mesh can be problematic with traditional clips. Feeders that are not firmly secured can be dislodged by the animals, leading to spillage of feed or water and potential injury to the animals. Also, animal enclosures come in different designs and wire mesh configurations. A clip that works well with one type of wire mesh may not be suitable for another, necessitating a versatile solution that can adapt to different enclosure styles and mesh thicknesses. Given these challenges, there is a need for an improved clip design that addresses the limitations of existing solutions.

### BRIEF SUMMARY

The present invention provides a novel two-way clip designed for hanging animal feeders and water containers within or outside wire mesh enclosures, such as those used for chickens, rabbits, and other small livestock. The clip includes a first end section configured to attach to a pivotal point on the feeder, enabling rotational movement, and a second end section designed to engage securely with various wire mesh structures, including both horizontal and vertical wires. The two end sections are connected by a cylindrical or otherwise shaped solid or hollow pipe, ensuring structural integrity and facilitating rotational functionality.

The second end section features a U-shaped hook with outwardly bent tips, enhancing stability by preventing accidental dislodgement from the wire mesh. This design allows for quick and easy attachment and detachment, accommodating wire mesh of varying thicknesses and configurations. The clip is fabricated from durable materials such as stainless steel or high-strength plastic, ensuring longevity and resistance to environmental conditions. Further enhancing its functionality, the clip includes features such as a pivot mechanism in the first end section for rotation, a locking mechanism to secure the feeder's position, and a quick-release mechanism for ease of use. The clip is also designed with rounded edges to prevent damage to the wire mesh and ensure animal safety. Additionally, the clip's ergonomic design allows for easy handling during attachment and detachment, while distributing the feeder's weight evenly across the wire mesh to reduce stress on individual wires.

This innovative clip offers significant advantages over traditional clips by providing dual functionality, allowing the feeder to be hung from either the inside or outside of the enclosure without removal and reattachment. This versatility, combined with its durable construction and ease of use, makes it a valuable solution for improving the efficiency and convenience of feeding and watering systems in animal husbandry. The clip's unique design and features ensure stable, secure attachment, meeting the diverse needs of various wire mesh enclosures and contributing to better animal care and management.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a diagram that illustrates a two-way clip, in accordance with an embodiment of the present invention.

FIG. 2 is a diagram that illustrates a feeder, in accordance with an embodiment of the present invention.

FIG. 3 is a diagram that illustrates the two-way clip being used for hanging the feeder from the outside of a cage, in accordance with an embodiment of the present invention.

FIG. 4 is a diagram that illustrates the two-way clip being used for hanging the feeder from inside of a cage, in accordance with an embodiment of the present invention.

FIG. 5 is a diagram that illustrates a first two-way clip used for hanging a first feeder from the outside of a cage and a second two-way clip used for hanging a second feeder from inside of the cage, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

Before describing the present invention in detail, it should be observed that the present invention utilizes a combination of components or set-ups, which constitutes a clip with a hooking mechanism designed to be attached to the side of a container or feeder or drinker. The clip features a first end section and a second end section connected by a cylindrical or solid pipe. This design allows the clip to securely hang the feeder or container or drinker from either the inside or outside of an animal cage with a wire mesh structure. The clip can be used without removal or reattachment, providing versatility and ease of use.

The invention will now be described with reference to the accompanying drawings which should be regarded as merely illustrative without restricting the scope and ambit of the present invention.

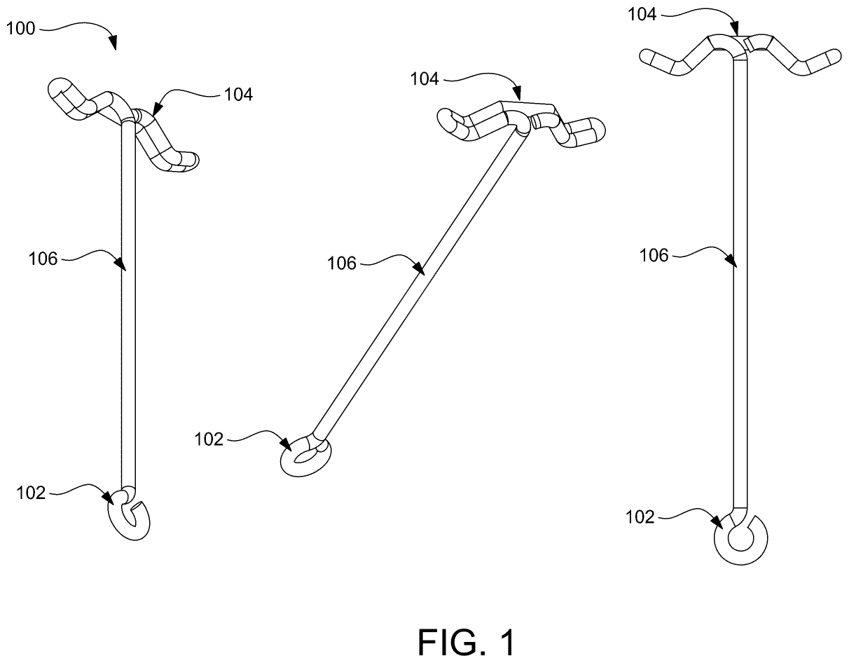

FIG. 1 is a diagram that illustrates a two-way clip 100, in accordance with an embodiment of the present invention. FIG. 1 illustrates the detailed structure and components of the two-way clip 100 designed for hanging animal feeders and water containers. The clip 100 consists of three primary sections: the first end section 102, the second end section 104, and the connecting pipe 106. Each component is engineered to ensure functionality, versatility, and ease of use.

The first end section 102 is designed as a hook-type mechanism with a circular opening. This circular opening allows the first end section 102 to be attached to a pivotal point on the feeder and/or a drinker or any other type of container. The pivotal point serves as the axis around which the clip can rotate, enabling the adjustment of the clip's or feeder's position. The hook-type design facilitates easy attachment and removal, allowing the user to secure the feeder to the clip quickly and effortlessly. This feature is particularly useful for repositioning the feeder or performing maintenance, as it eliminates the need for additional tools or complicated adjustments.

The second end section 104 features a U-shaped or W-shaped hook with outwardly bent tips. This design is crucial for engaging the wire mesh structures commonly found in animal enclosures. The U-shaped or W-shaped hook allows the clip to be securely attached to the wire mesh, while the outwardly bent tips enhance stability by preventing accidental dislodgement. This ensures that the feeder remains firmly in place, whether it is mounted inside or outside the enclosure. The second end section 104 is designed to accommodate various wire thicknesses and configurations, providing compatibility with a wide range of enclosure designs.

The connecting pipe 106 serves as the structural link between the first and second end sections 102 and 104. It is typically cylindrical in shape, though other solid or hollow pipe configurations may also be used. The connecting pipe 106 provides the necessary rigidity and support, ensuring that the clip 100 can handle the weight of the feeder and remain stable under different conditions. Additionally, the connecting pipe 106 facilitates the rotational movement of the first end section 102 around the pivotal point, allowing the feeder to be adjusted without detaching the clip from the enclosure.

The combination of these three components results in a versatile and robust clip that can be used to hang feeders and water containers from either the inside or outside of an animal enclosure. The first end section's 102 hook-type design with a circular opening allows for easy attachment and rotational adjustment, while the second end section's 104 U-shaped or W-shaped hook with outwardly bent tips ensures secure engagement with the wire mesh. The connecting pipe 106 provides structural integrity and supports the rotational functionality, making the clip an ideal solution for various feeding and watering needs in animal husbandry.

The two-way clip 100 may be constructed from materials chosen for their durability, strength, and resistance to environmental factors. The first end section 102, which features a hook-type design with a circular opening, is typically made from high-strength plastic or durable metal, such as stainless steel. High-strength plastic provides a lightweight yet robust option that can withstand the rotational stresses around the pivotal point. Stainless steel, on the other hand, offers superior corrosion resistance and durability, making it ideal for outdoor use and ensuring a long service life. The second end section 104, characterized by the U-shaped or W-shaped hook with outwardly bent tips, is also made from materials that ensure reliability and longevity. Stainless steel is commonly used for this part due to its excellent tensile strength and ability to maintain structural integrity under the weight of the feeder. The outwardly bent tips, designed to enhance stability and prevent dislodgement, benefit from the rigidity and wear resistance of stainless steel, ensuring they remain effective over prolonged use. The connecting pipe 106, which links the first and second end sections 102 and 104 and provides the necessary structural support, is typically made from the same durable metal, such as stainless steel or high-strength plastic, depending on the specific requirements of the application. The cylindrical or solid pipe configuration ensures that the clip can handle the feeder's weight without bending or breaking. Stainless steel is preferred for its exceptional strength and resistance to environmental factors like moisture and temperature variations, while high-strength plastic offers a corrosion-resistant, lightweight alternative.

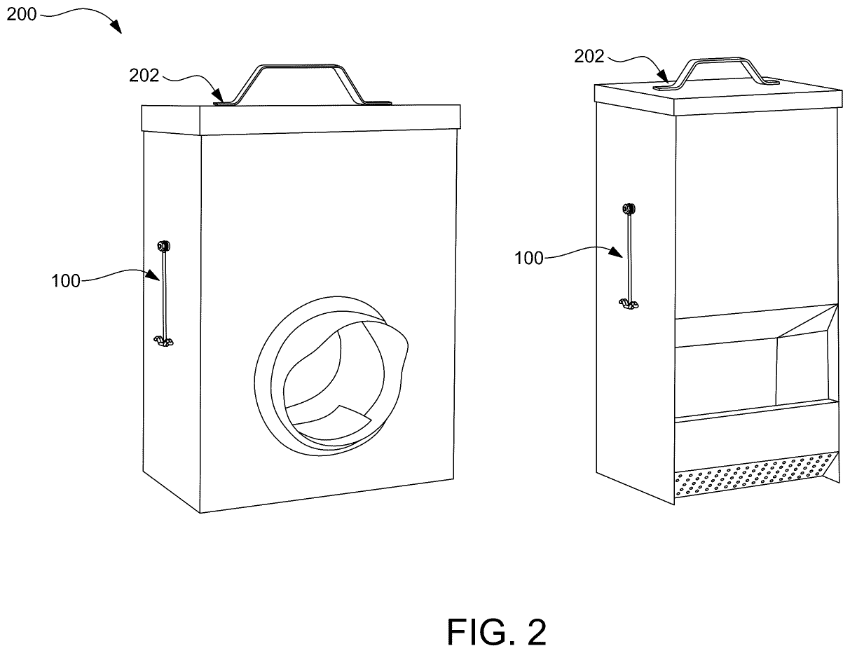

FIG. 2 is a diagram 200 that illustrates a feeder 202 with the attached two-way clip 100, in accordance with an embodiment of the present invention. FIG. 2 illustrates various types of feeders 202 designed for providing food and water to different types of animals such as chickens, and rabbits, each attached using the two-way clip 100. Each feeder 202 is equipped with two clips 100, one on each side, positioned opposite each other to ensure balanced and stable attachment within or outside an enclosure. The feeders 202 includes models for dispensing food and water, accommodating the needs of different animals such as chickens, rabbits, and other small livestock. Food feeders typically feature larger openings or troughs to allow easy access to pellets, grains, or other dry feed, while water feeders are designed with reservoirs or dispensers to provide a continuous supply of fresh water. Both types of feeders benefit from the secure attachment provided by the clips 100, ensuring that they remain accessible and stable, regardless of the animals' movements.

The attachment process of the clip 100 to the feeder 202 may involve a procedure. Each feeder 202 is equipped with pivotal points on its sides, designed to accommodate the circular openings of the first end sections 102 of the clips 100. To attach the clip 100, the user simply aligns the circular opening of the first end section 102 with the pivotal point on the feeder 202 and secures it in place. This attachment allows clip 100 to rotate around the pivotal point, facilitating easy adjustment and positioning. Once the first end section 102 is attached to the feeder 202, the second end section 104 of the clip 100 may be used to engage the wire mesh of the enclosure. The user hooks the second end section 104 onto the wire mesh, ensuring that the outwardly bent tips grip securely and prevent accidental dislodgement. This process is repeated for the second clip on the opposite side of the feeder 202, ensuring balanced support and stability.

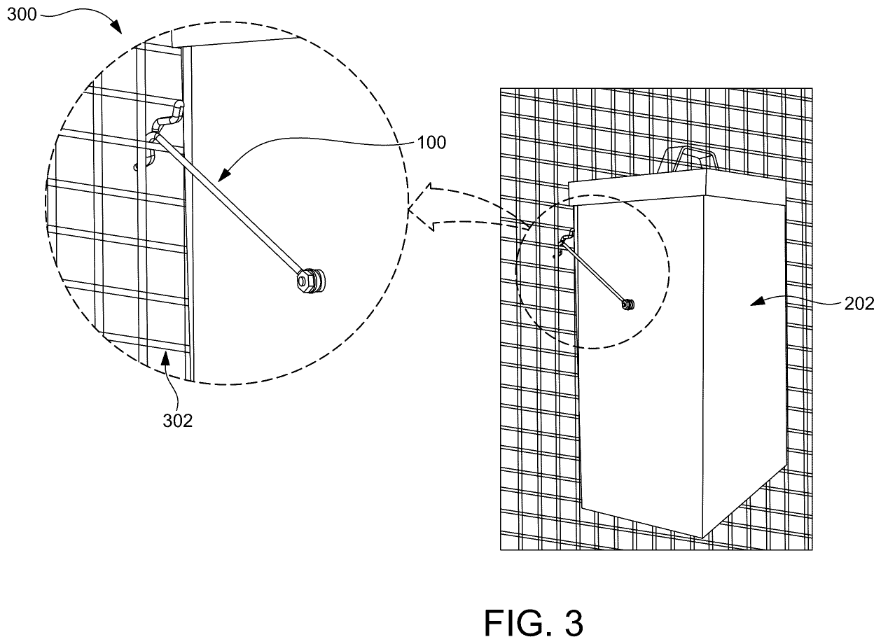

FIG. 3 is a diagram 300 that illustrates the two-way clip 100 being used for hanging the feeder 202 from outside of a cage 302, in accordance with an embodiment of the present invention. This configuration demonstrates one of the versatile functionalities of the clip 100, enabling easy access for replenishment while maintaining the feeder 202 securely attached to the enclosure. In this setup, the feeder 202 is positioned outside the cage 302, with the two-way clips 100 playing a crucial role in its attachment. The first end section 102 of each clip, which includes a hook-type design with a circular opening, is attached to pivotal points on either side of the feeder 202. These pivotal points allow the clip 101 to rotate around the feeder 202, providing flexibility in positioning and ease of access for cleaning or refilling. In other words, the second end section 104 of the clips is engaged with the wire mesh of the cage 302. The user hooks one end of the U-shaped or W-shaped section over the horizontal and vertical wires of the mesh, ensuring that the outwardly bent tips grip securely to prevent accidental dislodgement. This secure engagement is essential for maintaining the feeder's stability, especially when animals interact with it from the inside of the cage. Hanging the feeder 202 from the outside of the cage 302 offers several advantages. It prevents the animals from knocking over the feeder or soiling the food and water, thereby maintaining hygiene. Additionally, it allows for easier monitoring and refilling by the caretaker without needing to open the cage, reducing the risk of animals escaping or getting stressed. This outside mounting is particularly beneficial for larger or communal cages where space inside might be limited, or where multiple feeders need to be managed efficiently. The robust design of the two-way clips 100, made from durable materials like stainless steel or high-strength plastic, ensures that the feeder remains securely attached even under the weight of the food or water and the activity of the animals.

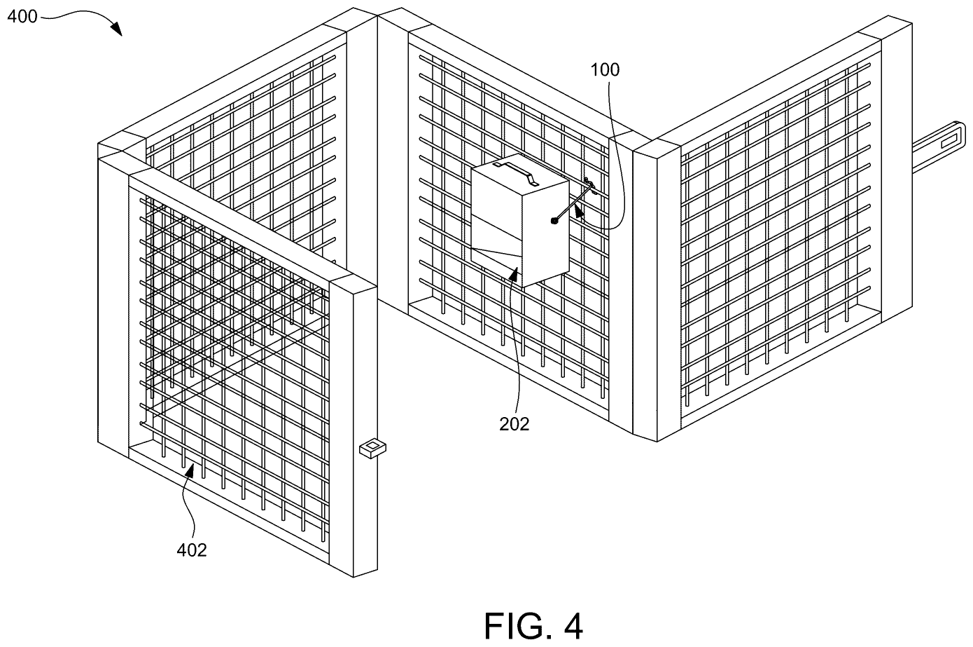

FIG. 4 is a diagram 400 that illustrates the two-way clip 100 being used for hanging the feeder 202 from inside of a cage 402, in accordance with an embodiment of the present invention. This configuration highlights the clip's versatility, allowing the feeder 202 to be securely mounted within the enclosure while providing easy access for the animals. In this setup, the feeder 202 is positioned inside the cage 402, with each side of the feeder 202 attached to the cage using the two-way clips 100. The first end section 102 of each clip is connected to pivotal points on the feeder 202. These pivotal points allow the clip 100 to rotate around the feeders or drinkers 202, facilitating convenient positioning and adjustment as needed. The second end section 104 of the clips may be engaged with the wire mesh of the cage 402. The U-shaped or W-shaped hook is slipped over the horizontal and vertical wires of the mesh, with the outwardly bent tips ensuring a secure grip that prevents the feeder from becoming dislodged. This secure attachment is crucial for maintaining the feeder's stability as animals interact with it. Hanging the feeder 202 from the inside of the cage 402 ensures that the animals have direct access to food or water while keeping the feeder protected within the enclosure. This setup is particularly useful for minimizing spillage and contamination, as well as for preventing the feeder from being knocked over by external forces. The robust and durable design of the clips 100 ensures that the feeder remains securely attached, even with the active engagement of the animals.

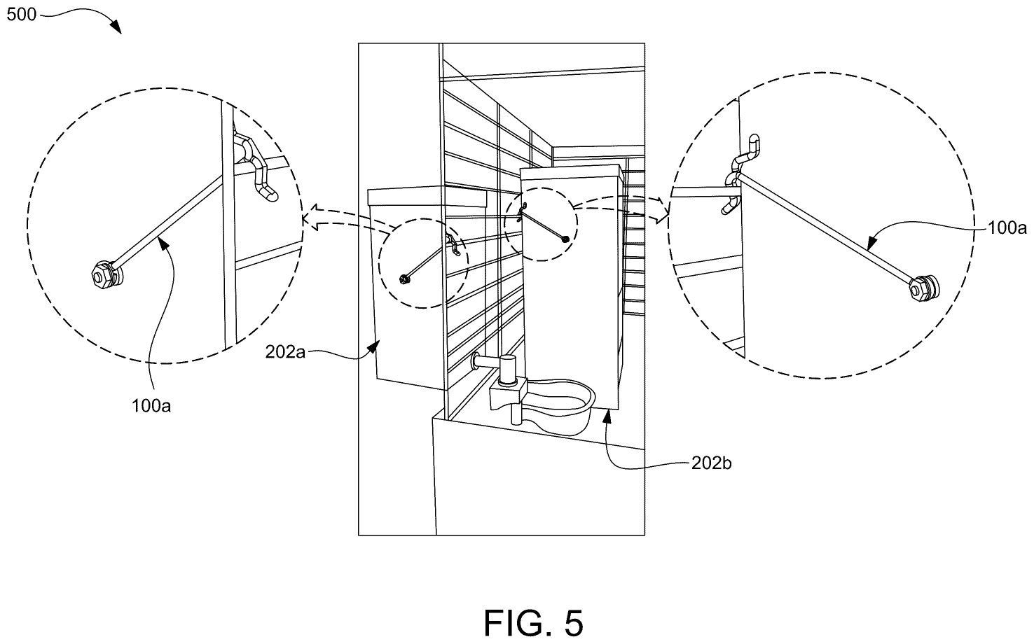

FIG. 5 is a diagram 500 that illustrates a first two-way clip 100a used for hanging a first feeder 202a from outside of a cage 502 and a second two-way clip 100b used for hanging a second feeder 202b from inside of the cage 502, in accordance with an embodiment of the present invention. In this configuration, a first two-way clip 100a is used to hang a first feeder 202a from the outside of a cage 502, while a second two-way clip 100b is used to hang a second feeder 202b from the inside of the same cage 502. This setup showcases the versatility and functionality of the two-way clips in accommodating different feeding arrangements within a single enclosure. Using two-way clips (100a and 100b) in this manner demonstrates their adaptability in different scenarios. The robust design and secure attachment mechanism ensure that both feeders remain stable and accessible, regardless of whether they are mounted inside or outside the cage. This dual arrangement provides flexibility in feeding strategies, catering to the specific needs and behaviors of the animals within the enclosure.

In summary, the clip 100 for hanging animal feeders or containers is innovatively designed with the first end section 102, the second end section 104, and the connecting member 106. The first end section is configured to attach to a pivotal point on a feeder, enabling rotational movement around this point. The second end section is designed to engage with wire mesh structures of animal enclosures, including both horizontal and vertical wires. The connecting member, extending between the first and second end sections, provides structural integrity and facilitates the rotational functionality of the clip. This design allows the clip to secure the feeder from either the inside or outside of the enclosure without requiring removal and reattachment. The connecting member is cylindrical in shape and can be formed from a solid pipe, enhancing the clip's robustness. The first end section includes a pivot mechanism to facilitate rotation around the pivotal point on the feeder, while the second end section comprises a hooking mechanism that is adjustable to accommodate wire mesh structures of varying thicknesses. Both the first and second end sections can be fabricated from durable metal materials or high-strength plastic, ensuring longevity and resilience. The hooking mechanism of the second end section is configured to securely engage with wire mesh structures that have at least one horizontal wire and one vertical wire. The first end section may also include a locking mechanism to secure the rotational position of the feeder, and the second end section can feature a quick-release mechanism for easy attachment and detachment from the wire mesh structure. Additionally, the clip may have a protective coating to prevent corrosion and wear due to environmental exposure, and the first and second end sections can be designed to interlock, providing additional stability when the feeder is mounted. The connecting member includes an ergonomic design to allow for easy handling and manipulation during attachment and detachment. The second end section comprises a U-shaped hook with outwardly bent tips, designed to securely engage with wire mesh structures. These outwardly bent tips enhance the clip's stability by preventing accidental dislodgement from the wire mesh. The second end section's design accommodates varying wire thicknesses and spacing, providing compatibility with different wire mesh configurations. It includes a locking feature formed by the outwardly bent tips, securing the clip in place once attached to the wire mesh. The U-shaped hook is dimensioned to fit securely over standard wire mesh used in animal enclosures, and the second end section is designed with rounded edges to prevent damage to the wire mesh and ensure the safety of the animals.

The foregoing descriptions of specific embodiments of the present technology have been presented for purposes of illustration and description. They are not intended to be exhaustive or to limit the present technology to the precise forms disclosed, and obviously many modifications and variations are possible considering the above teaching. The embodiments were chosen and described to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A clip for hanging animal feeders or containers, comprising:
a first end section, configured to attach to a pivotal point on a feeder, enabling rotational movement around the pivotal point;
a second end section, designed to engage with wire mesh structures of animal enclosures, including both horizontal and vertical wires; and
a connecting member, extending between the first and second end sections, providing structural integrity and facilitating rotational functionality,
wherein the first end section and the second end section are oriented and structured such that the clip can secure the feeder from either the inside or outside of the enclosure without requiring removal and reattachment of the clip.

2. The clip of claim 1, wherein the connecting member is cylindrical in shape.

3. The clip of claim 1, wherein the connecting member is formed from a solid pipe.

4. The clip of claim 1, wherein the first end section includes a pivot mechanism to facilitate rotation around the pivotal point on the feeder.

5. The clip of claim 1, wherein the second end section comprises a hooking mechanism that is adjustable to accommodate wire mesh structures of varying thicknesses.

6. The clip of claim 1, wherein the first end section and the second end section are fabricated from a durable metal material.

7. The clip of claim 1, wherein the first end section and the second end section are fabricated from a high-strength plastic material.

8. The clip of claim 1, wherein the hooking mechanism of the second end section is configured to securely engage with wire mesh structures that have at least one horizontal wire and one vertical wire.

9. The clip of claim 1, wherein the first end section includes a locking mechanism to secure the rotational position of the feeder.

10. The clip of claim 1, wherein the second end section includes a quick-release mechanism to facilitate easy attachment and detachment from the wire mesh structure.

11. The clip of claim 1, further comprising a protective coating on the clip to prevent corrosion and wear due to environmental exposure.

12. The clip of claim 1, wherein the first end section and the second end section are designed to interlock, providing additional stability when the feeder is mounted.

13. The clip of claim 1, wherein the connecting member includes an ergonomic design to allow for easy handling and manipulation during attachment and detachment.

14. The clip of claim 1, wherein the second end section comprises a U-shaped hook with outwardly bent tips, designed to securely engage with wire mesh structures, and wherein the outwardly bent tips of the second end section enhance stability of the clip by preventing accidental dislodgement from the wire mesh.

15. The clip of claim 14, wherein the second end section's design accommodates varying wire thicknesses and spacing, providing compatibility with different wire mesh configurations.

16. The clip of claim 14, wherein the second end section includes a locking feature formed by the outwardly bent tips, which secures the clip in place once attached to the wire mesh.

17. The clip of claim 14, wherein the second end section's U-shaped hook is dimensioned to fit securely over standard wire mesh used in animal enclosures.

18. The clip of claim 14, wherein the second end section is designed with rounded edges to prevent damage to the wire mesh and ensure the safety of the animals.
